(19) United States
(12) Patent Application Publication
(10) Pub. No.: US 2007/0007336 A1
(43) Pub. Date: Jan. 11, 2007

(54) Associating resources with artefacts

(75) Inventor: Timothy P. J. G. Kindberg, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/483,043

(22) Filed: Jul. 7, 2006

(30) Foreign Application Priority Data
Jul. 11, 2005 (GB) 0514013.2

(51) Int. Cl. G06K 5/00

(52) U.S. Cl. 235/382

(57) ABSTRACT

A method and service system are provided for enabling a user to access a resource associated with an intended usage zone of an artefact by reading an access code from a tag physically associated with the artefact. Prior to physical commitment of the artefact to the usage zone or its proxy, the tag access code is un-associated with the usage zone or resource in a user-accessible service system. Once the artefact has been physically committed to the usage zone or its proxy, the tag access code and a usage zone identifier are captured. The captured data is then used to establish an association in the user-accessible service system enabling the access code to be mapped to the resource or an identifier of the resource.

### FIELD OF THE INVENTION

The present invention relates to a method of enabling user access to a resource associated with an intended real-world usage zone of an artefact, the artefact having one or more associated tags which serve to provide resource access codes.

As used herein, the term “artefact” means any form of physical object; in many cases the artefact will be a poster or other item of advertising or informational material.

Furthermore, as used herein, the “usage zone” of an artefact includes specific locations such as an installation site for an artefact in the form of a poster (the site being where the poster is intended to be used by being read), general locations such as a postal code area or an area covered by a delivery round (the area being where an artefact is intended to be used), and zones that do not have a fixed geographic location such as a display zone for a poster inside a public transport vehicle.

The term “tag” as used herein means a passive or active element that can be used to provide an access code, and is integral with, incorporated in, attached or attachable to, or otherwise capable of being physically associated with a tangible artefact. Examples include, but are not limited to, barcodes or other machine readable indicia (whether visible, infra-red, magnetic etc. in form) that have been applied to, or formed integrally with, an artefact, and active or passive memory tags. Many machine-readable tag technologies are known and others are likely to be developed in the future; the present invention, whilst using such tags, is not limited to any particular type of tag whether existing or to be developed. As many such technologies are known, no description is given herein regarding the tags or how the access codes are read from the tags; it is, however, noted that in some cases a tag may permit the direct reading of an access code (such as when digitally stored in a memory tag) whereas in other cases a tag may hold an access code in a form that needs interpreting to provide the access code (such as when the access code is represented by a barcode).

The term “resource” as used herein in the context of what is be accessed using an access code, is intended to mean any form of data item or service. In the case of a service, this can be implemented as a program executed either remotely or, after download, at a user device. A service does not necessarily involve two-way interaction with a user and can, for example, simply be some form of logging service noting that a user has read an access code associated with an artefact at a particular usage zone.

### BACKGROUND OF THE INVENTION

It is well known to use a hand-held device to read an access code from a tag associated with an artefact, and then to use this access tag to retrieve a resource over the internet. For example, the access code can itself directly encode the URL of an internet resource. Alternatively and as is described in International Patent Application WO 9701137 (Neomedia), the access code may need to be mapped to the resource URL by a translation (resolution) service.

FIG. 1 of the accompanying drawings depicts a known prior art arrangement similar to that described in the above-mentioned International Application. In the FIG. 1 arrangement, a user is provided with a camera phone 12 capable of imaging a barcode 11 on a poster 10 and internally translating the barcode image into a text-string access code. The camera-phone 12 is arranged to pass the access code over a wireless link 13 (typically a cellular telephone wireless link) and a communications infrastructure 14 that may include the public internet, to a translation service system 15 (see arrow 18). The service system 15 holds a translation database 17 that serves to translate access codes to corresponding resource URLs; the service system uses this database to translate a received access code into the corresponding URL and then returns that URL to the camera phone 12 (arrow 18). The camera phone 12 then uses the returned URL to access the indicated resource 16, again via the wireless link 13 and the communications infrastructure 14 (see arrow 19).

Typically, there will be many copies (or “instances”) of the poster 10. Provided that the same resource is to be accessed regardless of the site where the poster 10 is installed, each instance of the poster 10 can be identical and the distribution and installation of the posters 10 is uncomplicated, the only initialization step required being to set into the database 17 the appropriate translation between access code and resource URL.

However, it is desirable to be able to customize the resource accessed from a particular instance of the poster 10 to the site at which that instance is installed. This can be achieved by requiring a user to send to the translation service system not only the access code but also an identifier of the site where the access code has been read—the translation service system then returns the URL of the resource corresponding to the access code and the site identifier. A drawback of this arrangement is that the user is required to capture two items of data which is not user friendly particularly as the second item, the site identifier, will be physically associated with the site and not the poster and therefore unlikely to be jointly readable with the poster tag containing the access code.

It is therefore known to make the access code encoded by a tag specific both to the resource and the site concerned. More particularly, a set of posters will be printed that are identical except for the access code encoded by the tag associated with each poster instance, and the translation database is set up to translate each access code into the URL of the corresponding site-dependent resource. Of course, this arrangement requires that each poster is installed at the correct site, namely the site associated with the access codes carried by the poster; to this end, the posters can be printed on the reverse with the intended installation site. However, considerable care still needs to be taken that the correct poster is delivered to each site. To ensure that posters have been correctly distributed, it is known to use a verification process involving the installer of the poster at a particular site using a hand-held device to capture both the access code encoded by the tag associated with the poster, and a site identifier located at the site (for example, a barcode). The captured data is then compared against a database giving the correct pairings of access codes and site identifiers in order to verify that the correct poster has been (or is about to be) installed at the current site. The need to install the correct poster instance at the correct site is cumbersome, notwithstanding that the above-described verification process can minimize the chances of errors.

### SUMMARY OF THE INVENTION

According to one aspect of the present invention, there is provided a method of enabling user access to a resource associated with an intended real-world usage zone of an artefact, the method comprising:
(a) physically committing the artefact and a physically-associated tag to said zone or a proxy therefor, the tag serving to provide a resource access code that prior to physical commitment of the tag to said zone or its proxy, is un-associated with the zone in a user-accessible service system;
(b) at the time of carrying out (a), or subsequently, capturing data comprising the access code, and a zone identifier; and
(c) using the captured data to establish an association in the user-accessible service system enabling the access code to be mapped to an identifier of the zone-dependent resource or an identifier thereof.

The present invention also envisages a service system, and apparatus comprising a device and service system, for use in implementing such method.

### BRIEF DESCRIPTION OF THE DRAWINGS

Embodiments of the installation method of the present invention will now be described, by way of non-limiting example, with reference to the accompanying diagrammatic drawings of the prior art and of embodiments of the invention, in which:

FIG. 1 is a diagram of a prior art system for enabling to access an internet resource by scanning a barcode to read a resource access code;

FIG. 2 is a diagram illustrating a first embodiment of the installation method of the present invention, in which a tag-derived access code is associated with a site-dependent resource identifier in a service system;

FIG. 3 is a diagram illustrating a second embodiment of the installation method of the present invention, in which a tag-derived access code is associated with a site-dependent resource identifier in a service system, there being multiple sets, each of one resource, associated with the site;

FIG. 4 is a diagram illustrating a third embodiment of the installation method of the present invention, in which multiple tag-derived access codes are associated with respective site-dependent resource identifiers, there being one set of multiple resources associated with the site;

FIG. 5 is a diagram illustrating a fourth embodiment of the installation method of the present invention, in which multiple tag-derived access codes are associated with respective site-dependent resource identifiers in a service system, there being multiple sets of multiple resources associated with the site;

FIG. 6 is a diagram illustrating a fifth embodiment of the installation method of the present invention, this embodiment being similar to the fourth embodiment but employing a different way of indicating set and suffix parameters to the service system;

FIG. 7 is a diagram illustrating a sixth embodiment of the installation method of the present invention, this embodiment being similar to the fourth embodiment but employing a further different way of indicating set and suffix parameters to the service system;

FIG. 8 is a diagram illustrating a seventh embodiment of the installation method of the present invention, this embodiment being similar to the sixth embodiment but with a common portion of multiple tag-derived access codes being associated with a site identifier in the service system; and

FIG. 9 is a diagram illustrating an eighth embodiment of the installation method of the present invention, this embodiment being similar to the sixth embodiment but with a common portion of a set of multiple tag-derived access codes being associated with a set-specific identifier in the service system.

### BEST MODE OF CARRYING OUT THE INVENTION

The embodiments of the invention described below relate to the installation of an artefact, in the form of a poster 21, at an usage zone comprising an installation site 20, the poster 21 at least at the completion of installation having one or more physically-associated tags, in the form of barcodes 23-25, that serve to provide respective access codes. As already indicated, the artefacts, usage zone, and tags can take other forms.

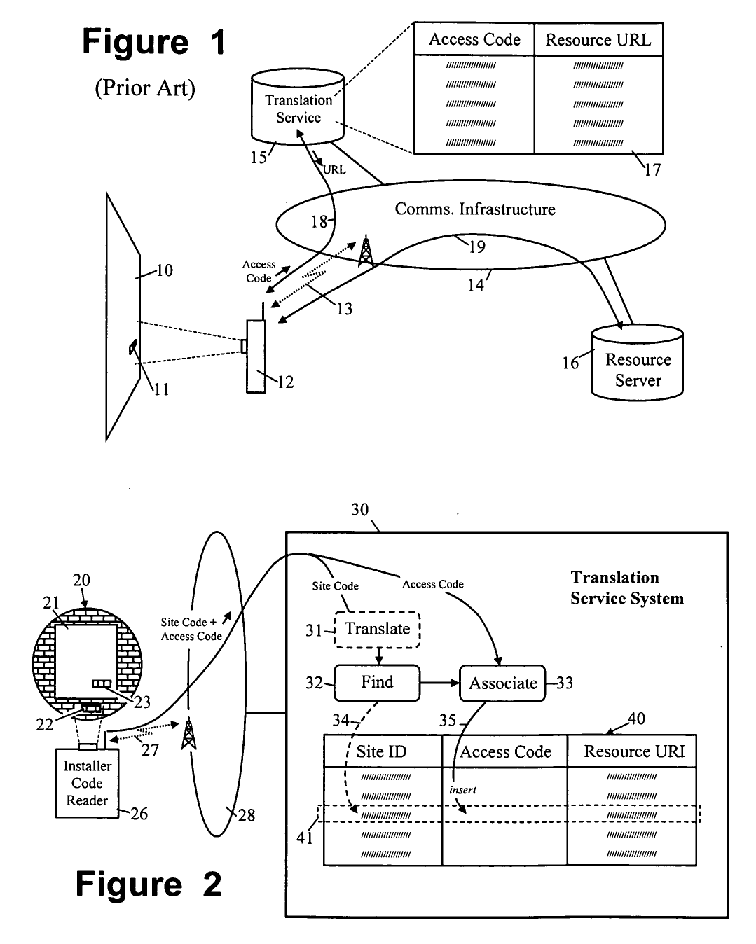

The process by which a user subsequently reads an access code and uses it to access the corresponding resource is not described as it is not part of the present invention; the process concerned is, however, similar to that already described with reference to FIG. 1.

Similar elements in the various embodiments have been given the same reference numerals and behave in substantially the same manner unless otherwise stated or implied by the operation of interacting elements. It may be noted that references hereinafter to the “poster 21” are, unless otherwise stated, intended to mean one specific poster instance rather than all instances of the same poster design that differ only in the associated access codes.

Turning now to a consideration of the first embodiment illustrated in FIG. 2, in this embodiment an installation site 20 has a single site-dependent resource associated with it. Upon an installer arriving at the site 20, the installer installs a poster 21 which carries a tag 23 in the form of a printed barcode encoding a resource access code. This code is, for example, a randomly generated number. At the time of arrival at the site 20 the resource code is un-associated with the site 20 in a user-accessible translation service system 30. The system 30 typically comprising a program-controlled data processor and storage subsystem.

The installer is provided with a hand-held device 26 which includes a barcode reader and which can communicate via a wireless link 27 and a communications infrastructure 28 with the translation service system 30. Typically, the wireless link 27 is provided by a wireless LAN or a Public Land Mobile Network, and the communications infrastructure 28 includes the public internet to which the service system 30 is connected. After putting up the poster 21, the installer uses the device 26 to capture the resource code encoded by tag 23; while still at the site the installer also uses the device 26 to capture a site identifier (site ID) and associate it with the captured access code. The site ID is depicted in FIG. 2 as being read by the device 26 from a barcode 22 physically associated with the site 20; however, the site ID can be captured in other ways such as by manual input (for example by the installer keying in a number displayed at the site or by installer selection from a list displayed on the device 26), or by capturing location parameters for use as the site ID (the location parameters are obtained, for example, using a GPS system built into the device 26 or by using a location service provided by a PLMN). The order of capture of the access code and the site ID is not important.

The captured data (access code, site ID) is then passed immediately to the translation service system 30 via the wireless link 27 and communications infrastructure 28.

The service system 30 holds a database 40 with a respective record for each site, as identified by site ID; each site record has a field for holding the URI (Uniform Resource Identifier) of the associated resource and a field for the corresponding access code. Prior to installation of the poster 20 at the site 20, the access code field of the corresponding site record is empty.

Upon receipt of the access code and site ID at the service system 30, a Find process 32 uses the site ID to look up the corresponding site record 41 (see dashed arrow 34). Prior to being used to look up the site record, the site ID may be translated in form (see dashed box 31); for example, where the site ID is in the form of a number, it may be translated into corresponding geographic coordinates using a translation table, not shown. For clarity, this translation process represented by box 31 is omitted from the depictions of the other embodiments of the present invention.

Upon the relevant site record 41 being found, an Associate process 33 inserts the access code received with the site ID into the relevant field of that record (see arrow 35), thereby establishing an association between the access code and the resource URI of the resource allocated to the site 20.

The translation service system 30 is now ready to provide a translation of the access code provided by tag 23 into the URI of the corresponding resource.

Although it is preferable that the access code and site ID captured at site 20 are passed to the service system 30 as soon as they are captured so that the association between access code and resource URI is immediately established, this is not essential and the installer can delay sending the captured data. Indeed, the device 26 need not have any remote communication capability provided it can store the captured access code and site ID in association, the captured data being uploaded to the service system after the installer returns to a facility provided with a suitable connection to the service system 30.

The first embodiment described above with respect to FIG. 2 although having the merit of simplicity, does not provide the flexibility that will be required in many situations. In particular, it will often be desired to have the resource that is accessed at a site dependent not only on the identity of the site but also on one or more other factors and, in particular, on the identity or type of the artefact concerned. For example, where the artefact is a poster, it is frequently desirable to have the resource to be accessed dependent both on the site identity and on the type of the poster (posters for different goods/services/events will generally need to be associated with different resources). Provision is therefore preferably made for each site to have multiple sets of associated resources with a set identifier being used to distinguish between sets associated with a site when asking the service system to associate a particular access code to a resource for an identified site. This set identifier is referred to below as the “set@site ID” (or simply the “set ID”) and it serves to distinguish between sets associated with a site rather than any specific set in an absolute sense.

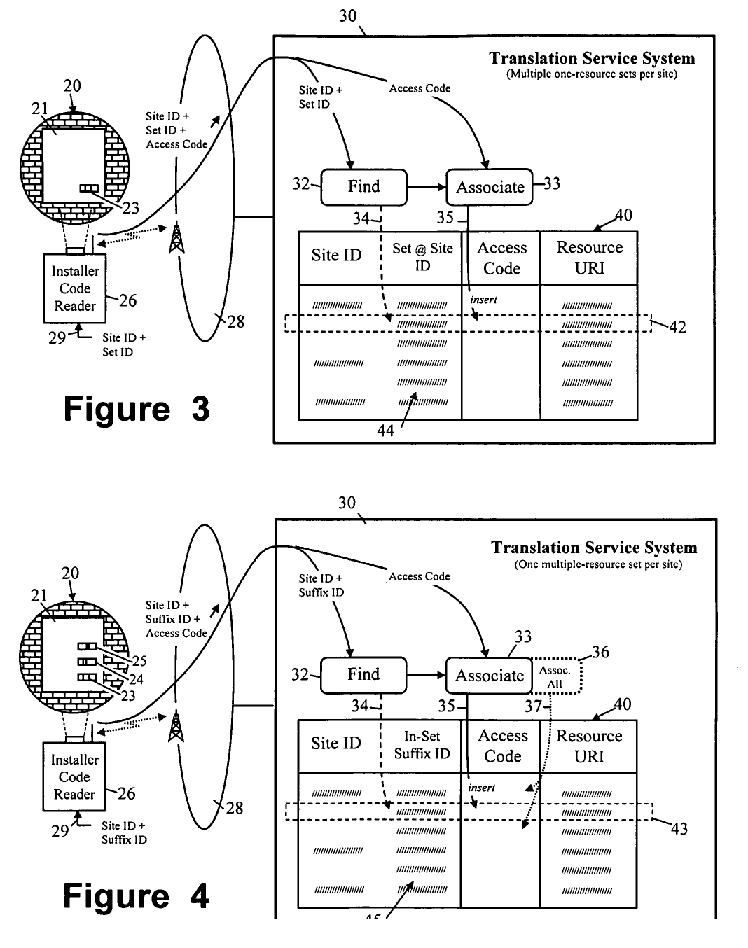

The second embodiment of the invention, illustrated in FIG. 3, relates to a situation where the poster 21 at site 20 still only has one associated tag 23 (and therefore one access code) at the completion of installation, but there are multiple sets, each of one resource, associated with the site 20. In this case, when the poster 21 is installed the service system 30 must be provided with a set@site ID for indicating which set is to be used, amongst the sets associated with the site 20, in order to be able to associate the received access code with the desired resource. Whilst the set@site ID will often be an indication of the type of the poster (or other artefact) this is not necessarily the case; for example, the set@site ID could be dependent on date.

The set ID is captured by the installer along with the site ID and access code at the time of installation of the poster 21 at site 20. This can be achieved in a number of different ways. In FIG. 3, the set ID is depicted as being manually input along with the site ID. Alternatively, the set ID can be indicated by the access code provided by the tag 23; for example, the access code can have a predefined structure with one part of the code explicitly forming the set ID, or there can be predetermined relationship between access code and set ID that is known to the service system (thus, all access codes relating, for example, to the third of the sets available at different sites can be associated in a memory of the service system, this association not itself indicating any particular site).

Regardless of the manner in which the set ID is captured by the installer device 26, it is passed in association with the site ID and access code to the service system 30. The database 40 now comprises multiple records for each site, each such record corresponding to a different set as identified by a set ID held in a field 44 of the record. Each record also includes a corresponding resource URI and an access code field. It will be appreciated that the structure and arrangement of the database 40 is merely illustrative and other database structures can be used.

The Find process 32 of the service system 30 uses the received site ID and set ID to find the corresponding record 42 (arrow 34). The Associate process 33 then inserts the received access code into the record (arrow 35) thereby establishing an association between the access code and the corresponding resource URI.

The third embodiment illustrated in FIG. 4, like the second embodiment, also provides for multiple resources to be associated with a site but this time the resources associated with a site are arranged in one set with the resources of the set being associated with different ones of multiple access codes associated with a single artefact at the site. More particularly, the poster 21 is now provided with three tags 23 to 25 each providing a respective access code that is to be associated with a different one of the resources associated with the site 20. To enable the service system 30 to associate a particular access code with the correct one of the resources associated with the site 20, an appropriate indication is provided to the service system as part of the data captured by the installer at the site 20; this indication is referred to as the “in-set suffix ID” (or just “suffix ID”) and serves to distinguish been resources in a set of resources. The suffix ID associated with a particular access code can be captured in any of the ways used in the second embodiment for capturing the site ID (manual input, explicit in access code, implicit in the access code by virtue of a predetermined relationship between access code and suffix ID that is known to the service system).

During installation of the poster 21 in the FIG. 4 embodiment, the installer captures the side ID and the access code of a first one of the tags—for example, tag 23. The suffix ID associated with that tag/access code is also captured and associated with the access code (in FIG. 4, the suffix code is depicted as being input manually). The captured data is then sent to the service system 30. The database 40 comprises multiple records for each site, each such record corresponding to a different in-set suffix as identified by a suffix ID held in a field 45 of the record. Each record also includes a corresponding resource URI and an access code field. It will again be appreciated that the structure and arrangement of the database 40 is merely illustrative and other database structures can be used.

The Find process 32 of the service system 30 uses the received site ID and suffix ID to find the corresponding record 43 (arrow 34). The Associate process 33 then inserts the received access code into the record (arrow 35) thereby establishing an association between the access code and the corresponding resource URI.

The same procedure can then be repeated in respect of the access codes provided by tags 24 and 25. However, preferably, provision is made for enabling the access codes of these other tags to be automatically associated with the correct resource URIs on the basis of the association established for the first read access code provided by tag 23. This is possible where a predetermined inter-relationship exists between the access codes and their suffix values.

Such an inter-relationship can be the result of a predictable progression of the access codes with suffix—for example, the access codes can have the suffix ID as their terminating element whereby if the access code associated with one suffix ID is known (that is, the first processed access code) then the access codes associated with the other suffix ID can be predicted and inserted into the corresponding records associated with the site concerned.

Another way of providing a known inter-relationship between access codes of a set and their respective suffix values is for the service system to have knowledge of which access codes are grouped together as a set and what is the association of access codes to suffix IDs in this grouping (this latter association can simply be provided by ordering the list in suffix order). In this case, the first processed access code serves to identify the relevant grouping of access codes and these codes can then be inserted according to their associated suffixes into the appropriate record for the site concerned. This arrangement does not require any particular structure for the access codes which can be random.

Dashed “associate all” box 36 and dotted arrows 37 in FIG. 4 depict the automatic association of all access codes with resource URI following the processing of a first one of the access codes.

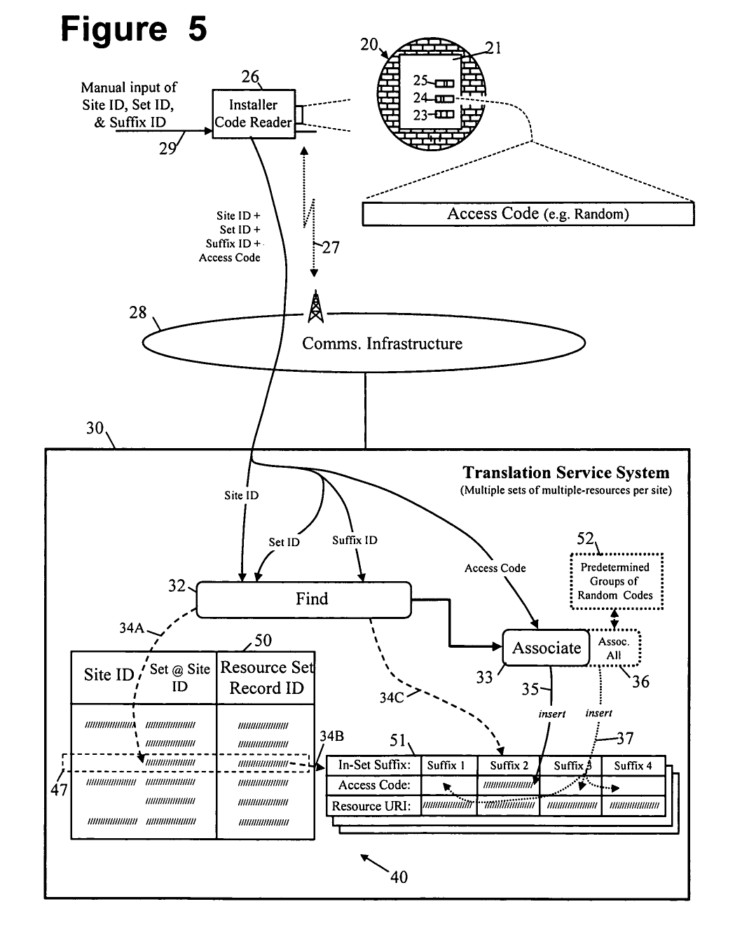

The fourth to eighth embodiments to be described hereinafter with reference to FIGS. 5 to 9 respectively, all relate to the situation where the site 20 has multiple associated sets of resources with at least the set of interest in relation to the poster 21 being installed having multiple resources. Thus the poster 21 has multiple tags 23-25 providing respective access codes that are to be associated with corresponding respective resources of a particular one of several sets of resources associated with the site 20. The fourth to eighth embodiments thus concern the combination of the situations depicted in the second and third embodiments and require both the use of a set@site ID and an in-set suffix ID to identify which resource of those associated with the site 20 is to be associated with a given access code.

In the fourth embodiment (FIG. 5), during installation the installer reads the access code of a first one of the tags 23-25 and manually inputs the set@site ID (for example, dependent on the subject of the poster) and in-set suffix ID (for example, dependent on the tag order position on the poster) that correspond to the read-in access code; the installer also manually inputs the site ID. The captured data is sent to the service system 30.

In this example the database 40 comprises a table 50 with a respective record for each combination of site and set; each such record holds the ID of a resource-set record 51. Each resource-set record 51 contains for each suffix associated with the set, the corresponding resource URI and a field for insertion of an access code. It will again be appreciated that the structure and arrangement of the database 40 is merely illustrative and other database structures can be used.

The Find process 32 of the service system 30 uses the received site ID and set ID to find the corresponding record 47 in table 50 (arrow 34A) and hence the corresponding resource-set record 51 (arrow 34B), and then uses the received suffix ID to locate (arrow 34C) the suffix column where the received access code is to be inserted. The Associate process 33 then inserts the received access code into the field concerned (arrow 35) thereby establishing an association between the access code and the corresponding resource URI.

The same procedure can then be repeated in respect of the access codes provided by tags 24 and 25. However, as for the third embodiment, provision is preferably made for enabling the access codes of these other tags to be automatically associated with the correct resource URIs in the resource-set record 51 on the basis of the association established for the first-read access code. In the FIG. 5 embodiment this is indicated as being achieved by arranging for the access codes to be arranged in predetermined ordered groups 52 whereby knowledge of one access code is sufficient to identify the group and the other access codes together with their associated suffix values. This enables an “associate all” process 36 to complete the access code fields in the resource-set record 51 already identified (see arrow 37).

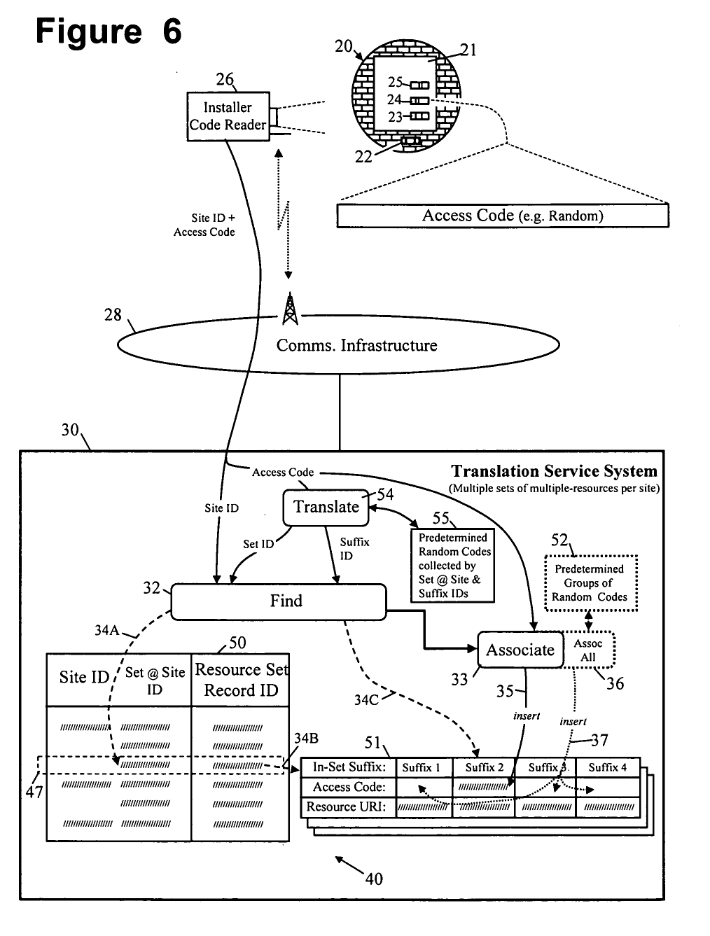

The fifth embodiment (FIG. 6) is similar to that of the fourth embodiment but now the site ID is read from a site-located tag 22, and the set@site ID and the in-set suffix ID are implicit in the access code read from any one of the tags 23-25 associated with the poster 21. More particularly, upon a first one of the access codes being provided to the service system, a translation process 54 uses the access code to derive the corresponding set and suffix IDs by reference to collections store 55 holding pre-stored collections of the access codes arranged both by set ID and by suffix ID (that is, all access codes with the same set ID are associated in first respective collections, and all access codes with the same suffix value are associated in second respective collections).

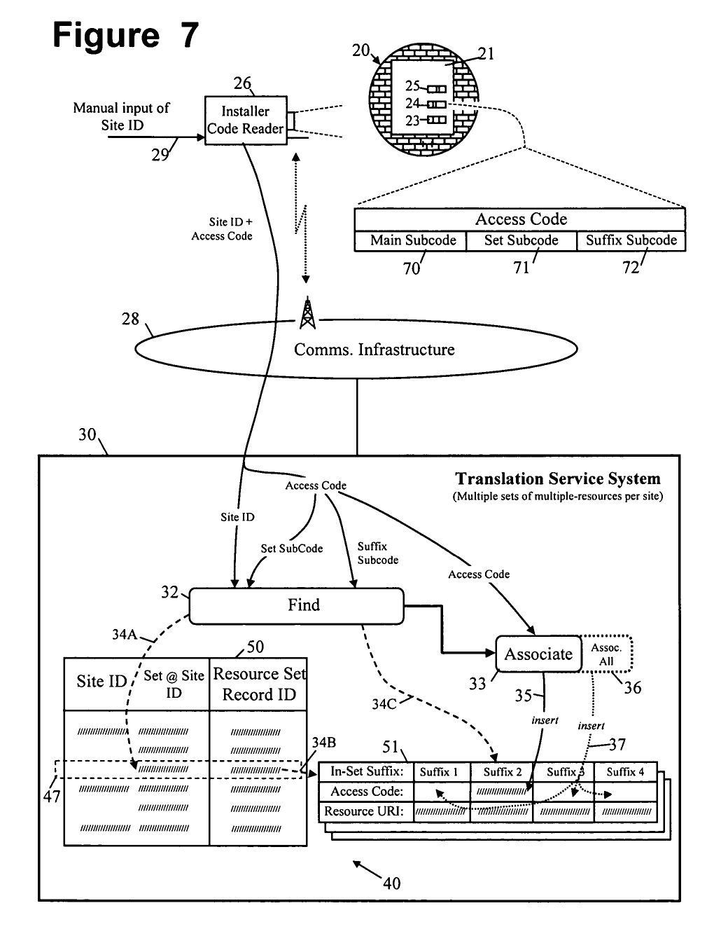

The sixth, seventh and eighth embodiments (FIGS. 7 to 9 respectively) all use a structured form of access code. In particular, each access code comprises a main subcode 70, a set subcode 71, and a suffix subcode 72. The main subcode 70 will generally be the same for all access codes associated with a particular poster instance 21 and effectively serves to provide uniqueness for these codes as compared with codes associated with other poster instances (or, indeed, other artefacts). The set subcode 71 serves as the set@site ID for the access code and the suffix subcode 72 serves as the in-set suffix ID for the access code (the set and suffix subcodes therefore do not themselves provide uniqueness to the access code across multiple artefacts). The set@site subcode will generally be the same for all access codes associated with a particular poster instance 21.

It may be noted that it is not intended that all posters 21 to be installed over time at the site 20 have the same main subcode 70 as this would require an unwarranted degree of organisation of poster distribution. It may further be noted that as the main subcode 70 and the set subcode 71 will generally be the same for all access codes associated with a particular poster instance 21, they can in many respects be considered as one.

By structuring the access codes in the foregoing manner, the installer need only capture the site ID and the access codes (or just one code if the “associate all” feature is employed) when installing the poster 21.

More particularly, and with reference to FIG. 7, in the sixth embodiment the installer inputs the site ID and reads a first one of the tags 23-25; the captured data is then passed to the service system 30 where the set subcode and suffix subcode are split off the access code to provide the set ID and suffix ID respectively. The site ID, set ID and suffix ID are then used to locate the corresponding resource-set record 51 and suffix column in the manner described above with reference to FIGS. 5 and 6; the access code is then inserted into the appropriate field thereby establishing an association between the access code and an resource URI. Preferably, the “associate all” process 36 nest alters the suffix subcode of the access code to generate the remaining access codes of the same set and insert them into the appropriate fields in the resource-set record 51.

With regard to the seventh and eighth embodiments, these take advantage of the fact that where an access code explicitly or implicitly indicates the set ID and/or suffix ID, the final association of an access code with a specific resource URI can be delayed until the user presents an access code to the service system. However, upon installation of the poster 21 the access codes still need to be associated with at least the relevant site in the translation service system 30.

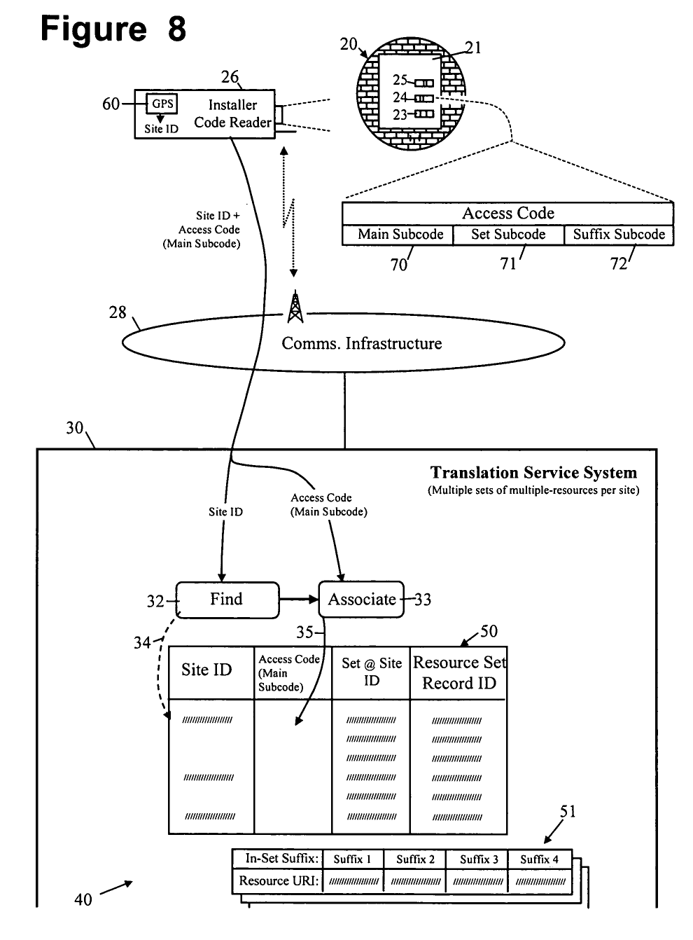

The seventh embodiment, shown in FIG. 8, is similar to that of FIG. 7 but now the association established in the service system upon installation of the poster 21 is an association between an access code and the site ID. In fact, since the access codes of the FIG. 8 embodiment are structured and arranged such that the main subcode 70 is not only the same for all the access codes associated with the particular instance of the poster, but the subcode 70 also provides the uniqueness to these codes (as compared to the access codes of other poster instances), it is only necessary to associate the main subcode 70 taken from one access code with the site ID in the database 40 of the service system 30. Thus on installing the poster 21, only the site ID and the main subcode 70 from one access code need be captured and sent to the service system.

It may be noted that in the FIG. 8 embodiment the site ID is depicted as being captured as the location coordinates of the site 20 as derived using a GPS unit 60 built into the device 26.

When the site ID and subcode 70 are received at the service system, the Find and Associate processes 32 and 33 operate to insert the subcode 70 against the site ID thereby establishing an association between the two. Upon a user subsequently sending an access code read from one of the tags 23-25, the translation service system 30 uses the main subcode 70 and set subcode 71 of the user-read access code to identify a corresponding resource set record 51, and further uses suffix subcode of the user-read access code to identify the URI of the particular resource to be accessed.

Whilst the FIG. 8 embodiment uses a form of access code that explicitly presents the set and suffix IDs (as subcodes), it will be appreciated that the set and suffix IDs can be implicitly contained in the access codes and derived when required to service a user, by means of the techniques described with respect to FIG. 6 (in particular, the translate process 54).

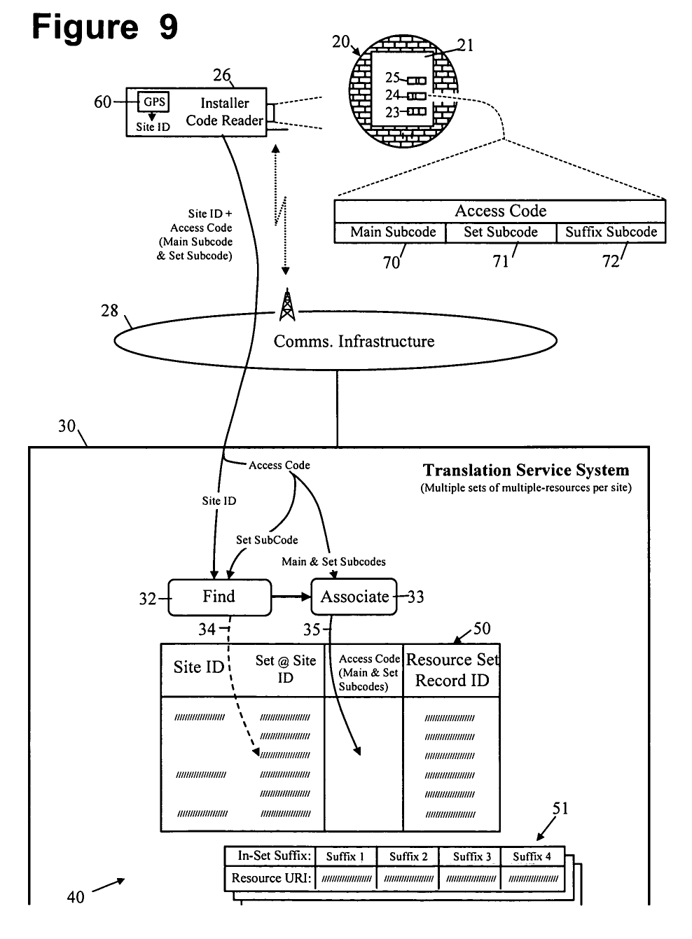

The eighth embodiment, shown in FIG. 9, is similar to the seventh embodiment but now at installation time an association is established in the database 40 of the service system between the main subcode 70 and set subcode 71 on the one hand and the site ID and set@site ID on the other hand. Again, this only requires the installer to capture the site ID and the main and set subcodes 70, 71 of one access code read from the poster 21. When a user subsequently reads an access code from the poster, the main and set subcodes of the user-read access code are used by the service system to identify the corresponding resource-set 51, and the suffix subcode 72 of the user-read access is used to identify the specific resource URI required.

It will be appreciated that many variants are possible to the above described embodiments of the invention. For example, the site ID itself can be structured in form with one part of the site ID identifying a general location and a second part identifying a particular location at the site for installing an artefact (thus two poster locations that are positioned one above the other may be distinguished by values added to the main part of the site ID).

In the illustrated embodiments of the invention it has been assumed that the resource URIs are already present in the service system database 40 at the time that the poster 21 is being installed. In fact, this is not necessary and the actual URIs could be inserted later into the appropriate fields of the database (the empty fields serving as placeholders). Indeed, the database can be built up dynamically as captured data is received—for example, in relation to the embodiments of FIGS. 5 to 9, whenever a previously unknown set ID is received in respect of a particular site ID, a new resource-set record can be created with placeholders for resource URIs.

As another variant of the illustrated embodiments, rather than storing resource URIs in the service system database 40, it is possible to store the resource items themselves.

It will be appreciated that the manner of communication between the installer device and the service system is not critical and, as already noted, can be effected by a delayed upload (for example, via a direct connection).

Where the service system 30 relies on pre-determined collections and/or groupings of access codes to derive set and suffix IDs and/or to effect an “associate all” function (see the embodiments of FIGS. 5 and 6), care must be taken to ensure the correctness of these collections/groupings. Thus, although it would be possible to decide these collections/groupings of access codes before the access codes are physically associated with artefacts, it is safer to generate the collections/groupings by reading the codes after placement (this would generally be done before distribution of the artefacts but could be done during the distribution and installation process).

It should be noted that although in describing the illustrated embodiments of the invention only one tagged artefact has been assumed to be installed at the site 20 at any one time, it is possible to have multiple tagged artefacts installed at the same site at the same time though this may require modification to the database structures shown. Thus whilst the database structures of FIGS. 5 to 9 permit tagged artefacts associated with different resource sets to be simultaneously present at the same site, it would not be possible to have multiple tagged artefacts that had different associated codes overall but which referred to the same set of resources. Persons skilled in the art will readily be able to provide alternative database structures permitting this extra flexibility. Similarly, the database structures disclosed above in relation to the embodiments of FIGS. 2 and 8 do not permit different access codes/different access-code main subcodes 70 to be associated with the same site ID; again, modification of the database structure to allow this flexibility will be apparent to persons skilled in the art.

The tags providing the access codes will typically be physically associated with the artefacts before installation of the latter at installation sites. However, it is also possible to physically associate the tags and artefacts during installation. For example, where the tags are memory tags, they can be adhered to the artefacts at the installation site (indeed, the tags can be written with their access codes on site, the access codes being ‘captured’ from the tag writing device rather than directly from the tags themselves). Where the tags take the form of indicia displayed by the artefacts, these indicia can be applied to the artefacts on site and, again, the access codes represented by the tags can be ‘captured’ from the printing device (or other type of device used to apply the indicia).

The service system 40 can be distributed in form and can be arranged such that the associations established by the installation process and required for translating a user-read access code into a resource URI, are held separately from the rest of the service system (in other words, in relation to the FIG. 5 embodiment for example, the resource-set records 51 can be held separately in a user-accessible part of the service system, the remainder of the system being inaccessible to a user—taken as a whole, the service system is still to be considered as user accessible).

In all the embodiments described above, the usage zone of the artefact has been a static installation site. However, as already indicated, this is only one possible form of the usage zone. In other embodiments of the invention, the usage zone can take different forms, for example:
in an embodiment concerning the installation of posters inside a public transport vehicle, the usage zone of the posters is the interior of the vehicle;
in an embodiment concerning magazines to be sold in a particular locality, the usage zone is that locality (in this embodiment, the magazines are, for example, delivered to a store in the locality and the store staff are responsible for capturing the access codes off each magazine and sending them, together with the other necessary data, such as a locality identifier, to the service system database). This embodiment can advantageously be applied to any type of artefact sold by a store.

In the above-described embodiments of the invention, the binding of an access code physically associated with an artefact to the artefact usage zone (or to the resources/resource URIs/URI placeholders associated with the artefact usage zone), is done at the time of physical commitment of the artefact to the usage zone (for example, when a poster artefact is installed at an installation site). It is also possible, though not necessarily desirable, to effect the binding subsequent to the physical commitment of the artefact and its physically-associated access code to the usage zone. Another possibility is to effect the binding at the time the artefact, with its physically-associated access code, is physically committed to a usage zone proxy. For example, where the artefacts are magazines with printed access codes, a usage zone proxy can take the form of a dispatch area in a distribution center, the dispatch area being specific to the usage zone where the magazines are to be read (thus, the dispatch area could be specific to a store located in a locality constituting the intended usage zone, or the dispatch area could be specific to a delivery round serving the locality); the artefact can, of course, be something other than a magazine.

Another example of a usage zone proxy is an envelope addressed with a particular postal code where that postal code identifies the usage zone for the artefact, typically advertising material, that is to be put in the envelope; in this case, at the time the artefact is put in the envelope, the access code on the artefact is bound to the usage zone (or related resource/resource URI/URI placeholder) identified by the postal code on the envelope. A similar example is the introduction of advertising material (the artefact with associated access code) into newspapers already sorted by delivery round, the delivery round serving to identity the usage zone. In both these last two examples, the usage zone proxy can be seen to be an item already allocated for delivery to the usage zone.

A further example of a usage zone proxy is a public transport vehicle in the situation where a poster (artefact) is attached to the outside of the vehicle for display along a particular route that constitutes the usage zone; the artefact will generally be physically committed (attached) to the vehicle at a depot outside the usage zone, it being convenient to bind an access code carried by the poster to the usage zone (or related resource/resource URI/URI placeholder) at this time.

1. A method of enabling user access to a resource associated with an intended real-world usage zone of an artefact, the method comprising:
(a) physically committing the artefact and a physically-associated tag to said zone or a proxy therefor, the tag serving to provide a resource access code that prior to physical commitment of the tag to said zone or its proxy, is un-associated with the zone in a user-accessible service system;
(b) at the time of carrying out (a), or subsequently, capturing data comprising the access code, and a zone identifier; and
(c) using the captured data to establish an association in the user-accessible service system enabling the access code to be mapped to the zone-dependent resource or an identifier thereof.

2. A method according to claim 1, wherein said association established in the user-accessible database is between the access code and the resource identifier or a placeholder therefor.

3. A method according to claim 2, wherein to accommodate multiple resource identifiers being associated with said zone and organised as at least one set each of at least one resource identifier, the data captured in (b) further comprises:
where there are, or are to be, multiple said sets associated with the zone, a set identifier for distinguishing between sets associated with the zone; and
where there are or are to be, multiple resource identifiers in a set, an index for distinguishing between resource identifiers in the set;
the service system in (c) using the zone identifier together with any set identifier and any index in the captured data, to associate the access code with a corresponding resource identifier or placeholder therefor.

4. A method according to claim 3, wherein a said set identifier is included in captured data and comprises one of:
an explicit portion of the access code;
at least a portion of the access code that has been pre-bound in the service system to a set value distinguishing between said sets;
an identifier separate from the zone identifier and access code.

5. A method according to claim 3, wherein a said index is included in captured data and comprises one of:
an explicit portion of the access code;
at least a portion of the access code that has been pre-bound in the service system to an index value;
an identifier separate from the zone identifier and access code.

6. A method according to claim 5, wherein in order to enable a user to access any one of a set of multiple zone-dependent resources, the artefact is physically committed to the usage zone, or its proxy, along with a plurality of tags physically associated with the artefact, each tag serving to provide a respective resource access code that prior to physical commitment of the tag to said zone or its proxy is un-associated with the zone in the user-accessible service system, but in respect of which a respective said association is subsequently established in the user-accessible service system.

7. A method according to claim 6, wherein (b) and (c) are performed in respect of each tag to establish a respective said association between the access code of each tag and a corresponding resource identifier or placeholder therefor.

8. A method according to claim 6, wherein in (b) data is captured in respect of one tag only, (c) establishing a respective said association between the access code of each tag and a corresponding resource identifier by using a predetermined inter-relationship between the access codes and their index values.

9. A method according to claim 8, wherein said inter-relationship is a predictable variation of access code for different index values.

10. A method according to claim 8, wherein said inter-relationship is provided by a previously stored grouping of the access codes that indicates the index value associated with each access code.

11. A method according to claim 1, wherein:
in order to enable a user to access any one of a set of multiple zone-dependent resources, the artefact is physically committed to the usage zone, or its proxy, along with a plurality of tags physically associated with the artefact, each tag serving to provide a respective resource access code that prior to physical commitment of the tag to said zone or its proxy, is un-associated with the zone in the user-accessible service system, but in respect of which a respective said association is subsequently established in the user-accessible service system;
in (b) data is captured in respect of one tag only, this data including an index value for distinguishing between said tags; and
in (c) a respective said association between the access code of each tag and a corresponding resource identifier or placeholder therefor is established by using a predetermined inter-relationship between the access codes and corresponding index values.

12. A method according to claim 1, wherein to accommodate multiple resource identifiers being associated with the zone:
the said association established in (c) in the user-accessible database is between the access code and the zone identifier; and
the access code is adapted, in a manner known to the service system, to distinguish between resources associated with the zone.

13. A method according to claim 1, wherein to accommodate multiple resource identifiers being associated with the zone and organised as multiple sets each of at least one resource identifier:
the said association established in (c) in the user-accessible database is between the access code and a specific said set; and
where said specific set comprises multiple resources, the access code is adapted, in a manner known to the service system, to distinguish between the resources of the set.

14. A method according to claim 1, wherein in (b) data is captured using a hand-held device, the captured data being sent via a radio link directly or indirectly to the service system.

15. A method according to claim 1, wherein the artefact is a poster and the tag or tags are in the form of machine-readable markings.

16. A method according to claim 15, wherein the usage zone is a static installation site for the poster, the poster being physically committed to the usage zone by being installed for display at the site.

17. A method according to claim 15, wherein the usage zone is the interior of a public transport vehicle, the poster being physically committed to the usage zone by being installed for display in the vehicle.

18. A method according to claim 1, wherein the usage zone is a locality served by a store, the artefact being physically committed to the usage zone by delivery to the store.

19. A method according to claim 1, wherein the usage zone is a locality served by a store or by a delivery round, the artefact being physically committed to a usage zone proxy by being physically allocated to the store or a delivery round in a distribution center.

20. A method according to claim 1, wherein the usage zone is a location or locality to which an item is allocated for delivery, the item serving as a proxy for the usage zone and the artefact being physically committed to the proxy by being physically associated with the item.

21. A service system comprising:
a data store for storing association data associating real-world artefact usage zones with corresponding resources;
an association arrangement for receiving a data message comprising a resource access code as yet un-associated in the service system with a said real-world usage zone, and a zone identifier identifying a said usage zone; the association means being arranged to use said data message to modify said association data to establish an association for enabling the access code to be mapped to a zone-dependent resource or an identifier thereof, and
a user-accessible translation arrangement for receiving a user-input access code and using said association data to map the input access code to a zone-dependent resource or an identifier thereof which is then output to the user.

22. Apparatus comprising:
the service system of claim 21; and
a portable device for capturing both a resource access code from a tag physically-associated with an artefact physically committed to a usage zone or a proxy therefor, and a zone identifier identifying a said usage zone, the device being arranged to form the captured resource access code and zone identifier into a said data message and to send that message to the service system.
